(19) United States
(12) Patent Application Publication
(10) Pub. No.: US 2008/0182222 A1
(43) Pub. Date: Jul. 31, 2008

(54) ILLUMINATING DEVICE FOR DENTAL HANDPIECES

(76) Inventor: Chin-Fu Li, JHONGHE (TW)

Correspondence Address: CHIN-FU LI, P.O. BOX 11192, TAIPEI, 10099, omitted

(21) Appl. No.: 11/551,695

(22) Filed: Oct. 20, 2006

(51) Int. Cl. A61C 3/00

(52) U.S. Cl. 433/29

(57) ABSTRACT

An illuminating device for dental handpieces is disclosed. The illumination device comprises a positioning shell, an illuminating component, a cable, a connector and a power supply. The positioning shell may be manufactured by using the plastic injection molding process, and has a shape suitable to accommodate different types of handpieces. The positioning shell comprises a groove on a top side thereof for holding the illuminating component. The illuminating component is electrically coupled to an external power supply. The illuminating device of the present invention may be used for providing the illuminating light during the operations. Thus, the disadvantages of replacing the entire handpieces when the illumination device malfunctions may be effectively eliminated. Thus, not only the cost can be reduced but also the brightness of the illumination can be increased providing convenience during the operations.

This application claims the priority benefit of a R.O.C patent application serial No. 0095217803 filed on Oct. 5, 2006, now pending in Taiwan.

### BACKGROUND OF THE INVENTION

1. Field of the Invention

The present invention relates to an illuminating device, and more particularly to an illuminating device, which can be directly installed onto a dental handpieces for synchronous operations, to serve as a light source there-for.

2. Description of the Related Art

Commonly used dental handpieces with illuminating device and other illuminating components may comprise an illuminating component fixed to the far end under the neck part of the handpieces in the proximity of the head end, and whose electrical connection are also required to go through the contact of the handpieces and connector so as to couple with a wire and connected to an external power supply via a dental flexible hose.

However, although such a dental handpieces with illuminating device can provide the illumination function, however the electrical connection and the like are directly fixed to the handpieces. As different types of handpieces are required for different operations, the dentist has to purchase several handpieces with illuminating device and thus expensive for the dentists. The costs of such dental handpieces with illuminating device are approximately 4 to 5 times higher than the well-known dental handpieces without illuminating device, and in a case when the illuminating component in the illuminating device of the dental handpieces malfunctions, it is required to either repair it perform or replace it. This may interrupt or delay the operation and increase the cost.

Accordingly, the present invention provides a cost effective illuminating device which can be easily assembled to different types of handpieces, and thus reduce the cost.

### SUMMARY OF THE INVENTION

Accordingly, an object of the present invention is to provide a cost effective illuminating device which can be easily assembled to different types of handpieces.

In accordance with the aforementioned objective and other objectives of the present invention, the illumination device comprises a positioning shell, an illuminating component, a cable, a connector and a power supply. The positioning shell may be manufactured by using the plastic injection molding process, and has a shape suitable to accommodate different types of handpieces. The positioning shell comprises a groove on a top side thereof for holding the illuminating component. The illuminating component is electrically coupled to an external power supply. The illuminating device of the present invention may be used for providing the illuminating light during the operations. Thus, the disadvantages of replacing the entire handpieces when the illumination device malfunctions may be effectively eliminated. Thus, not only the cost can be reduced but also the brightness of the illumination can be increased providing convenience during the operations.

### BRIEF DESCRIPTION OF THE DRAWINGS

FIG. 1 shows a perspective view of an illumination device according to an embodiment of the present invention.

FIG. 2 shows a perspective view of an illumination device according to an embodiment when viewed from another angle.

FIG. 3 shows a perspective view of an illumination device according to another embodiment of the present invention.

FIG. 4 is a view showing the assembly of the illumination device according to an embodiment of the present invention.

FIG. 5 shows a perspective view of an illumination device according to a preferred embodiment of the present invention.

### DETAIL DESCRIPTION OF THE INVENTION

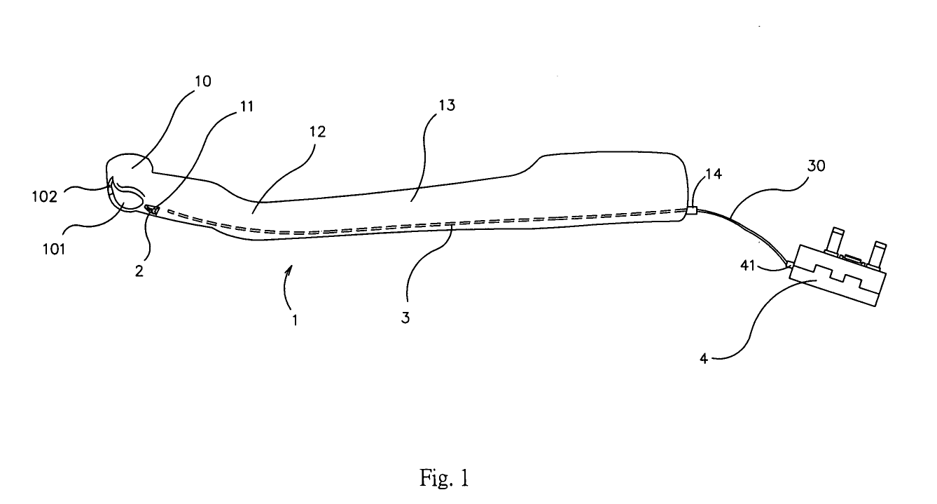

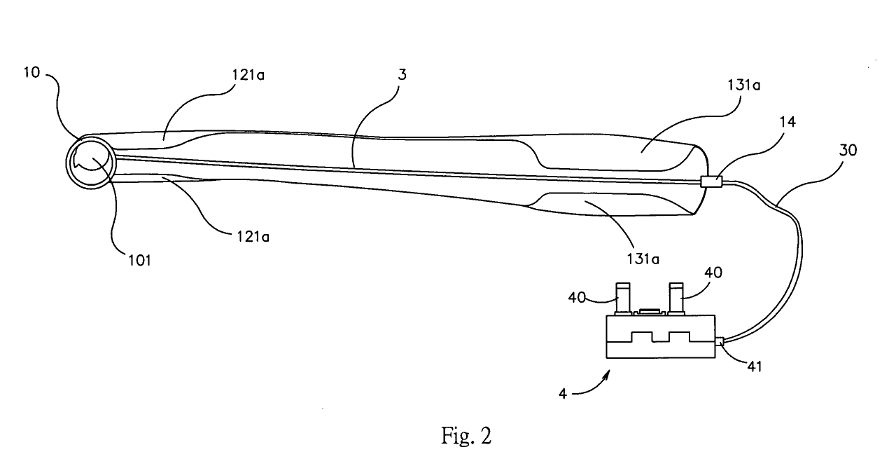

FIG. 1 shows a perspective view of an illumination device according to an embodiment of the present invention. FIG. 2 shows a perspective view of an illumination device according to an embodiment when viewed from another angle. Referring to FIGS. 1 and 2, the illumination device of the present invention comprises a positioning shell 1, an illuminating component 2, a cable 3 and a power supply 4. The positioning shell 1 may be manufactured by using, for example but not limited to, a plastic injection molding process.

The positioning shell 1 comprises a long arch shaped shell comprising a sleeve 10, a groove 11, a bending portion 12, a handheld portion 13 and a connector 14. The sleeve 10 is vertically located at a front end of the positioning shell 1 and comprises a piercing hole 101 at a central region thereof, and a U-shaped nick 102 is disposed at a front end of the piercing hole 101. A bending portion 12 is located at a side opposite to the U-shaped nick 102, wherein both sides of the bending portion 102 respectively extend downward and form a first clamp 121, and wherein both sides of the first clamp respectively extend to form an arc-shaped clamp pad 121a, in order to promote the holding effect. A groove 11 is disposed at a joint portion at the backside of the bending portion 12 and the sleeve 10. The other end of the positioning shell 1 serves as a handheld portion 13. A second clamp is disposed on a side of the handheld portion 13 and the bending portion 12, wherein the second clamp also extends to form two arc shaped clamp pads 131a. A connector 14 is disposed at an end of the second clamp.

The illuminating component 2 may be an LED or any other light emitting devices, and may be held inside the groove 11. The illuminating component 2 is electrically connected to the cable 3 and plugged to the connecting cable 30 through the connector 14. The other end of the connecting cable 30 is connected to the power supply 4. The dorsal end of the handheld part 13 of the positioning shell 1 is connected to the connector 14 such that the connecting cable 30 and the illuminating component 2 may be detachably connected.

One end of the connecting cable 30 can be fixed to the positioning shell 1 and the other end thereof is connected to a connector for coupling with the power supply 4 to achieve an electrical connection.

Alternatively, one end of the said connecting cable 30 may also be fixed to the power supply 4, and the other end thereof may be connected a connector for coupling with the positioning shell 1 to achieve an electrical connection.

Furthermore, the connector of the positioning shell 1 can be directly connected to the power supply 4.

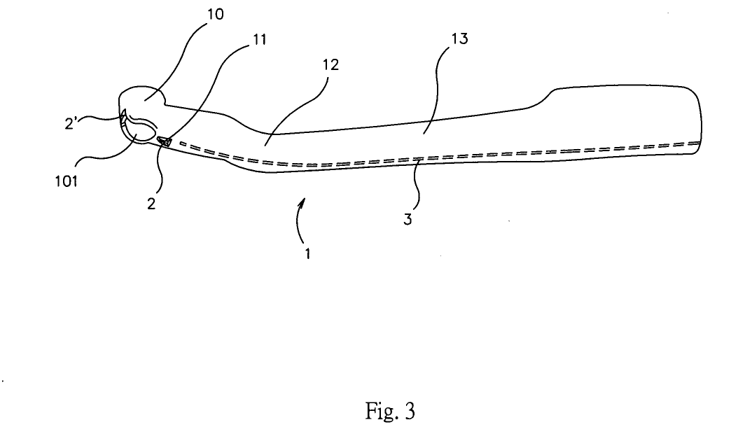

FIG. 3 shows a perspective view of an illumination device according to another embodiment of the present invention. Referring to FIG. 3, the illuminating component 2 may be directly held on the front end of the U-shaped nick 102 to illuminate toward the front direction to facilitate different operations.

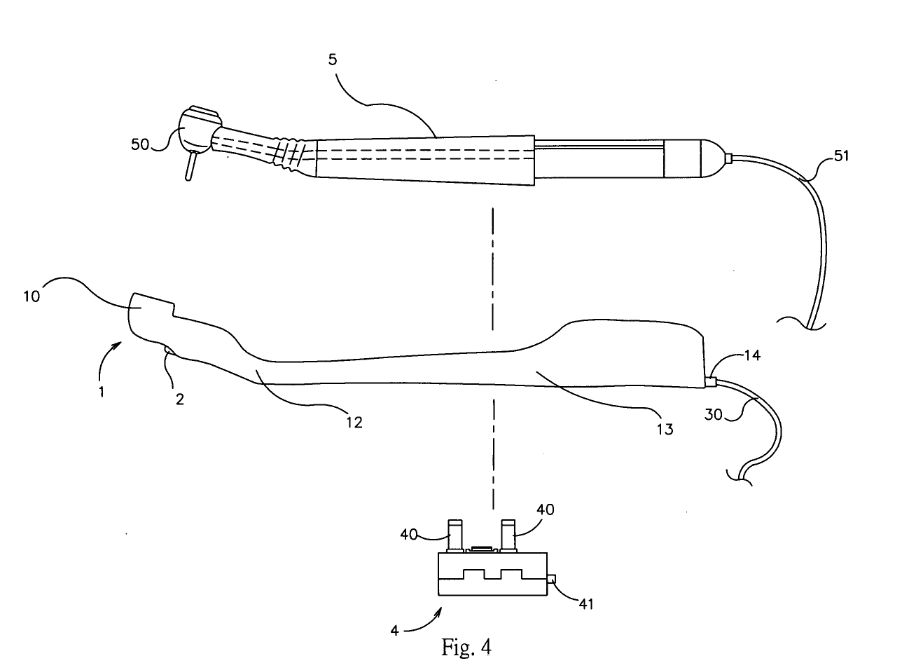

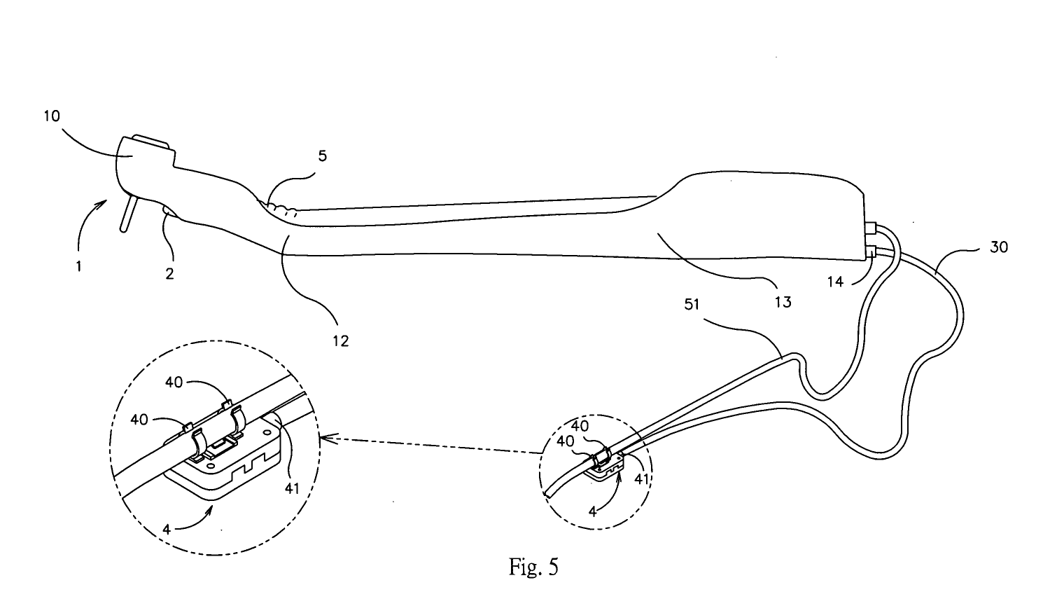

FIG. 4 is a view showing the assembly of the illumination device according to an embodiment of the present invention. FIG. 5 shows a perspective view of an illumination device according to a preferred embodiment of the present invention. Referring to FIGS. 1, 4 and 5 together, the illuminating component 2 is inserted into the groove 11 of the positioning shell 1 where it is held and connected to the connector 14 through the cable 3. Thereafter, the motor head 50 of the handpiece 5 may be inserted into the sleeve 10 and body of the handpiece 5 may be then pressed down into the positioning shell 1 until neck part and dorsal part of the handpieces 5 are respectively detachably locked by the first clamp 121 and the second clamp 131. Thus, the handpiece 5 can be detachably secured in the positioning shell 1 by the first and second clamp pads 121a and 131a.

The positioning shell 1 may be manufactured by using a flexible plastic material, and therefore it may be possible to fit different types of handpieces into the positioning shell 1. The electrical cable 51 may be fixed by way of clamp locking by the two clamp parts 40 located on the upper side the power supply 4 onto of the handpiece 5.

According to an embodiment of the present invention, the power supply 4 can be a battery, and the connector 41 of the power supply 4 can provide charging/discharging functions to recharge the rechargeable battery which serves as the power source. During the operations, the power supply 4 can supply power to the illuminating component 2 through the connector 41. Alternatively, electricity may be supplied to the power supply 4 through the same connector 41 when charging.

In summary, the present invention has at least the following advantages.

1. The positioning shell may be detachably assembled to different types of handpieces to provide illumination function during operations.

2. The sleeve of the positioning shell can securely position the motor head of the handpiece to securely fit the handpiece to the positioning shell, and the first clamp and the second clamp can be used to securely hold on the neck and dorsal parts of the handpiece.

3. The plastic material of the positioning shell renders the positioning shell suitable for assembling onto different types of handpieces. Thus, the cost can be substantially reduced.

4. The positioning shell may be made of sterilizable plastic material so that it can be sterilized and reused several times.

5. The illuminating component may be an LED so that the brightness of the illumination can be enhanced.

6. The charging and discharging feature of the power supply can provide increased convenience of use, and reduce the concerns of power leakage that may hurt human body.

The aforementioned illustrations represent merely the preferred embodiments of the present invention, all equivalent modifications, alternations and changes in design to the following claims are to be encompassed by the technology of the present application.

In summary, the present invention can improve many disadvantages of the conventional dental handpieces including the handpieces with and without the light illuminating device.

### DESCRIPTION OF COMPONENT SYMBOLS IN DRAWINGS

1 Positioning Shell
2 Illuminating Component
3 Cable
4 Power Supply
5 Handpieces
10 Sleeve
11 Groove
12 Bending Part
13 Handheld Part
14 Connector
30 Connecting Cable
41 Connector
50 Motor Head
51 Electrical Cable
101 Piercing Holes
102 U-shaped Nick
121a Clamp pad
131a Clamp pad

### DESCRIPTION OF MAJOR COMPONENT SYMBOLS

### Assigned Major Diagram: FIG. 1

1 Positioning Shell
2 Illuminating Component
3 Cable
4 Power Supply
10 Sleeve
11 Groove
12 Bending Portion
13 Handheld Portion
14 Connector
30 Connecting Cable
41 Connector
101 Piercing Holes
102 U-shaped Nick

What is claimed is:

1. An illuminating device for dental handpieces comprising a positioning shell comprising a sleeve, a bent portion, a handheld portion, an illuminating component, a cable and a connector, wherein the illuminating component is electrically connected to the connector through the cable.

2. The illuminating device for dental handpieces as claimed in claim 1, wherein a first clamp pad extends from two sides of the bent portion respectively.

3. The illuminating device for dental handpieces as claimed in claim 1, wherein a second clamp pad extends from two sides of a dorsal end of the handheld portion respectively.

4. The illuminating device for dental handpieces as claimed in claim 1, wherein the illuminating component comprises an Light Emission Dipole (LED).

5. The illuminating device for dental handpieces as claimed in claim 1, wherein a groove is formed at a bottom side of the sleeve for holding the illuminating component.

6. The illuminating device for dental handpieces as claimed in claim 1, wherein the positioning shell is thermally sterilizable.

7. An illuminating device for dental handpieces comprising a positioning shell an illuminating component, a cable and a connector, wherein the positioning shell comprises a sleeve, a bent portion, a handheld portion, and wherein a groove is formed at a conjunction between an upper end of the bent portion and the sleeve for holding the illuminating component, and the illuminating component is electrically connected to the connector through the cable.

8. The illuminating device for dental handpieces as claimed in claim 7, wherein the connector is electrically coupled to a power supply and two locking portions are formed on the power supply.

9. The illuminating device for dental handpieces as claimed in claim 7, wherein one end of the connecting cable is fixed to the positioning shell and the other end thereof is coupled to the power supply.

10. The illuminating device for dental handpieces as claimed in claim 7, wherein one end of the connecting cable is fixed to the power supply and the other end thereof is connected to the connector.

11. The illuminating device for dental handpieces as claimed in claim 7, wherein the connector is directly coupled to a power supply.
